(19) United States
(12) Patent Application Publication
(10) Pub. No.: US 2024/0129951 A1
(43) Pub. Date: Apr. 18, 2024

(54) EXPOSED NODE ISSUE CONFIGURATIONS IN WIRELESS SYSTEMS

(71) Applicant: Intel Corporation, Santa Clara, CA (US)

(72) Inventor: Laurent Cariou, Milizac (FR)

(21) Appl. No.: 18/398,756

(22) Filed: Dec. 28, 2023

(51) Int. Cl. H04W 74/0816; H04W 74/08

(52) U.S. Cl. CPC H04W 74/0816; H04W 74/0866; H04W 84/12

(57) ABSTRACT

An apparatus of an access point (AP) includes memory and processing circuitry configured to encode a trigger frame for transmission to a plurality of station devices (STAs) in a wireless network. A first request frame received from a STA of the plurality of STAs is decoded. The first request frame requests the AP to create a protected period for the STA when the STA is in an exposed node situation. A second request frame is encoded for transition to at least a second AP. The second request frame requests the at least second AP to establish a restricted target wake time (rTWT) for the STA. A first response frame from the at least second AP is decoded. The first response frame includes an indication of whether the rTWT is established. A second response frame is encoded for transmission to the STA. The second response frame includes the indication.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments;

FIG. 2 illustrates front-end module (FEM) circuitry in accordance with some embodiments;

FIG. 3 illustrates radio integrated circuit (IC) circuitry in accordance with some embodiments;

FIG. 4 illustrates a functional block diagram of baseband processing circuitry in accordance with some embodiments;

FIG. 5 illustrates a WLAN in accordance with some embodiments;

FIG. 6 illustrates a block diagram of an example machine upon which any one or more of the techniques (e.g., methodologies) discussed herein may be performed;

FIG. 7 illustrates a block diagram of an example wireless device upon which any one or more of the techniques (e.g., methodologies or operations) discussed herein may be performed;

FIG. 8 illustrates multi-link devices (MLD)s, in accordance with some embodiments;

FIG. 9 illustrates collocated and non-collated MLDs, in accordance with some embodiments;

FIG. 10 is a network diagram illustrating an example network environment using request and response frames to address an exposed node issue in a wireless network, in accordance with some embodiments; and

FIG. 11 is a flow diagram of an example method for using a prioritized channel access in a wireless network with an exposed node, in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for those of other embodiments. Embodiments outlined in the claims encompass all available equivalents of those claims.

In a Wi-Fi network, the Basic Service Set Identifier (BSSID) serves a crucial role, functioning as the MAC address of a wireless access point (AP). It uniquely identifies each AP within a network. Within a complex network environment, such as a large building or campus, a Multiple BSSID (MBSSID) set may be implemented. This configuration is a group of APs working in unison to provide robust and comprehensive network coverage.

The term “Transmitted BSSID” or TxBSSID refers to an AP within the Multiple BSSID set that is actively engaged in transmitting Beacon frames. Beacon frames are information packets periodically emitted by the AP to declare its presence and communicate critical information such as SSID, MAC address, and employed security protocols to any devices scanning for available networks. In a Multiple BSSID set, the role of sending Beacon frames for all the APs within the set, including those for the non-transmitting BSSIDs, falls to the TxBSSID. This design decision significantly reduces the overhead that would otherwise be incurred if each AP were to send its own Beacon frames.

On the other hand, “Non-Transmitted BSSID” or NonTxBSSID represents the APs within the Multiple BSSID set that are not tasked with the active transmission of Beacon frames. The responsibility of Beacon frame transmission for these APs is undertaken by the TxBSSID. However, this lack of Beacon transmission should not be misinterpreted as these APs being inactive or not contributing to network coverage. On the contrary, NonTxBSSIDs are fully operational APs that provide network coverage and cater to connected devices. Their non-participation in Beacon frame transmission in the Multiple BSSID set configuration is a strategy to optimize network resources.

In some aspects, a new Access Category (AC) or a new prioritized access can be configured for predictable latency, which can be referred to as AC_PL.

In some aspects, the prioritized access is defined as follows:
(a) A fixed time after the start of a contention period (for instance, using arbitration inter-frame spacing number (AIFSN) of 1, so that it is always more aggressive than AC_VO that is using AIFSN=2), a STA that has data queued for the new AC_PL can immediately transmit a Defer Signal.
(a.1) The goal of that transmission is such that all STAs that are participating in the contention period and that were not allowed to transmit a Defer Signal, will receive this Defer Signal, thus their clear channel assessment (CCA) will signal busy, and will defer for a particular duration that depends on the type of defer signal defined for this new AC.
(a.2) Another goal is that multiple STAs that have packets queued in their AC_PL would then be simultaneously transmitting this Defer Signal. To address this, a Defer Signal can be used so that even if multiple STAs transmit this Defer Signal at the same time, a 3rd party STA that receives the overlapping Defer Signals will have the same impact, meaning that it will trigger its CCA so that it defers and halts the EDCA process.
(b) Once the Defer Signal is sent, the STAs that sent a Defer Signal will be the only ones that can still decrement their backoff counters and contend for the medium. These parameters can be used in the same way as currently used for an AC like AC-VI or AC_VO. In addition, the proposal allows for the possibility of a larger maximum contention window size (CWmax) in order to tolerate more STAs. Or it could be simplified to just one CW, which would be simply scaled dynamically through signaling by the AP and would be set so that the number of collisions is bounded (and the CW will be small).

In some aspects, specific rules can be configured to regulate how STAs are allowed or not to use such prioritized access and whether or not they are allowed to send Defer Signals within an enhanced distributed channel access (EDCA) contention period.

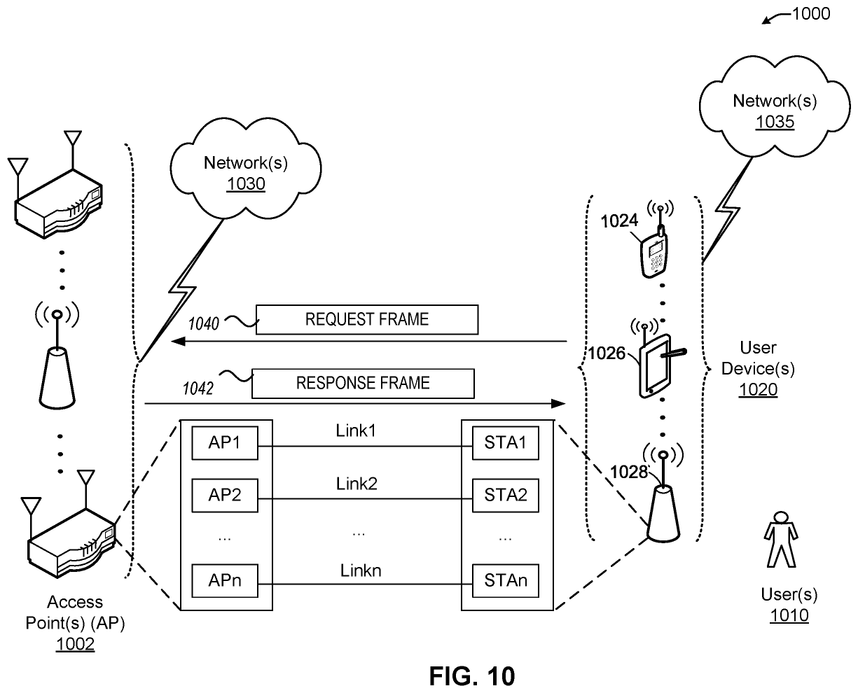

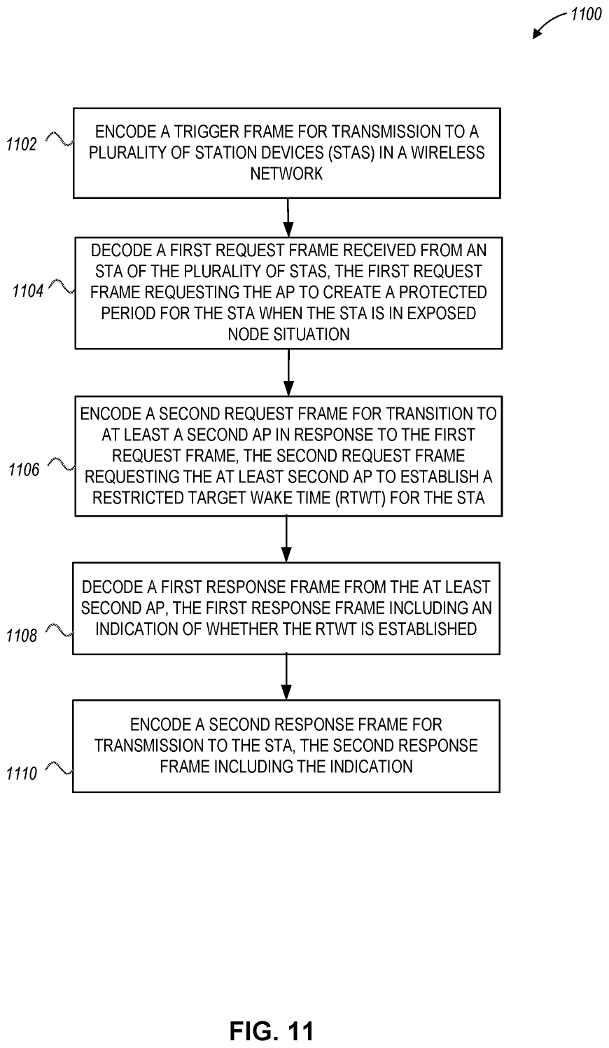

In some aspects, a cap in these enhancements can be detected when there are many overlapping basic service sets (OBSSs) and many STAs in a simulation. This can be due to some STAs still experiencing poor latency with or without the defer signal mechanism because they happen to have their network allocation vector (NAV) set very often when there is a contention period. This is referred to the STA being in an exposed node situation for an extended period. The disclosed techniques can be used to address the exposed node situation experienced by some STAs. Further description of the proposed techniques is provided in connection with, e.g., FIGS. 10-11 and corresponding figure descriptions.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

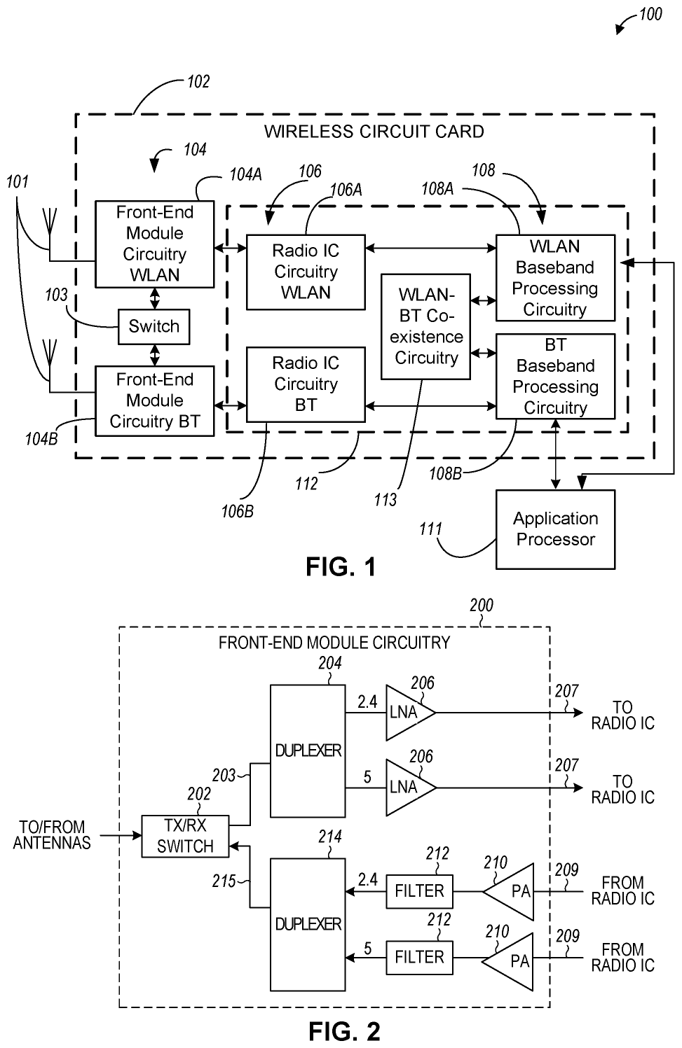

FIG. 1 is a block diagram of a radio architecture 100 in accordance with some embodiments. Radio architecture 100 may include radio front-end module (FEM) circuitry 104, radio IC circuitry 106, and baseband processing circuitry 108. Radio architecture 100, as shown, includes both Wireless Local Area Network (WLAN) functionality and Bluetooth (BT) functionality, although embodiments are not so limited. In this disclosure, “WLAN” and “Wi-Fi” are used interchangeably.

FEM circuitry 104 may include a WLAN (or Wi-Fi) FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals, and to provide the amplified versions of the received signals to the WLAN radio IC circuitry 106A for further processing. The BT FEM circuitry 104B may include a receive signal path, which may include circuitry configured to operate on BT RF signals received from one or more antennas 101, to amplify the received signals, and to provide the amplified versions of the received signals to the BT radio IC circuitry 106B for further processing. WLAN FEM circuitry 104A may also include a transmit signal path which may include circuitry configured to amplify WLAN signals provided by the WLAN radio IC circuitry 106A for wireless transmission by the one or more antennas 101. In addition, BT FEM circuitry 104B may also include a transmit signal path which may include circuitry configured to amplify BT signals provided by the BT radio IC circuitry 106B for wireless transmission by one or more antennas. In the embodiment of FIG. 1, although WLAN FEM circuitry 104A and BT FEM circuitry 104B are shown as being distinct from one another, embodiments are not so limited and include within their scope the use of a FEM (not shown) that includes a transmit path and/or a receive path for both WLAN and BT signals or the use of one or more FEM circuitries where at least some of the FEM circuitries share transmit and/or receive signal paths for both WLAN and BT signals.

The radio IC circuitry 106, as shown, may include WLAN radio IC circuitry 106A and BT radio IC circuitry 106B. The WLAN radio IC circuitry 106A may include a receive signal path, which may include circuitry to down-convert WLAN RF signals received from the WLAN FEM circuitry 104A and provide baseband signals to WLAN baseband processing circuitry 108A. BT radio IC circuitry 106B may, in turn, include a receive signal path which may include circuitry to down-convert BT RF signals received from the BT FEM circuitry 104B and provide baseband signals to BT baseband processing circuitry 108B. The WLAN radio IC circuitry 106A may also include a transmit signal path which may include circuitry to up-convert WLAN baseband signals provided by the WLAN baseband processing circuitry 108A and provide WLAN RF output signals to the WLAN FEM circuitry 104A for subsequent wireless transmission by one or more antennas 101. BT radio IC circuitry 106B may also include a transmit signal path which may include circuitry to up-convert BT baseband signals provided by the BT baseband processing circuitry 108B and provide BT RF output signals to the BT FEM circuitry 104B for subsequent wireless transmission by the one or more antennas 101. In the embodiment of FIG. 1, although radio IC circuitries 106A and 106B are shown as being distinct from one another, embodiments are not so limited and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband processing circuitry 108A and the BT baseband processing circuitry 108B may further include one or more processors and control logic to process the signals received from the corresponding WLAN or BT receive signal path of the radio IC circuitry 106 and to also generate corresponding WLAN or BT baseband signals for the transmit signal path of the radio IC circuitry 106. Each of the baseband processing circuitries 108A and 108B may further include a physical layer (PHY) and medium access control layer (MAC) circuitry and may further interface with the application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband processing circuitry 108A and the BT baseband processing circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the one or more antennas 101 are depicted as being respectively connected to the WLAN FEM circuitry 104A and the BT FEM circuitry 104B, embodiments include within their scope the sharing of one or more antennas as between the WLAN and BT FEMs or the provision of more than one antenna connected to each of the WLAN FEM circuitry 104A or the BT FEM circuitry 104B.

In some embodiments, the FEM circuitry 104, the radio IC circuitry 106, and baseband processing circuitry 108 may be provided on a single radio card, such as wireless radio card 102. In some other embodiments, one or more antennas 101, the FEM circuitry 104, and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be a part of a Wi-Fi communication station (STA) such as a wireless access point (AP), a base station, or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards, including IEEE 802.11n-2009, IEEE 802.11-2012, IEEE 802.11-2016, IEEE 802.11ac, and/or IEEE 802.11ax standards and/or proposed specifications for WLANs. However, the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax and 802.11be standards. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation. However, the scope of the embodiments is not limited in this respect.

In some embodiments, as further shown in FIG. 1, the BT baseband processing circuitry 108B may be compliant with a Bluetooth (BT) connectivity standard such as Bluetooth, Bluetooth 4.0, Bluetooth 5.0, or any other iteration of the Bluetooth Standard. In embodiments that include BT functionality, as shown, for example, in FIG. 1, the radio architecture 100 may be configured to establish a BT synchronous connection-oriented (SCO) link and/or a BT low energy (BT LE) link. In some of the embodiments that include functionality, the radio architecture 100 may be configured to establish an extended SCO (eSCO) link for BT communications. However, the scope of the embodiments is not limited in this respect. In some of these embodiments that include a BT functionality, the radio architecture may be configured to engage in BT Asynchronous Connection-Less (ACL) communications. However, the scope of the embodiments is not limited in this respect. In some embodiments, as shown in FIG. 1, the functions of a BT radio card and WLAN radio card may be combined on a single wireless radio card, such as the wireless radio card 102, although embodiments are not so limited and include within their scope discrete WLAN and BT radio cards

In some embodiments, the radio architecture 100 may include other radio cards, such as a cellular radio card configured for cellular (e.g., 3GPP such as LTE, LTE-Advanced, or 5G communications).

In some IEEE 802.11 embodiments, the radio architecture 100 may be configured for communication over various channel bandwidths, including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. However, the scope of the embodiments is not limited concerning the above center frequencies.

FIG. 2 illustrates FEM circuitry 200 in accordance with some embodiments. The FEM circuitry 200 is one example of circuitry that may be suitable for use as the WLAN FEM circuitry 104A and/or the BT FEM circuitry 104B (of FIG. 1). However, other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the FEM circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by the one or more antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum, as shown. In these embodiments, the transmit signal path of the FEM circuitry 200 may also include a power amplifier 210 and one or more filters 212, such as a BPF, an LPF, or another type of filter for each frequency spectrum and a transmit signal path duplexer 214 to provide the signals of one of the different spectrums onto a single transmit path for subsequent transmission by the one or more antennas 101 (FIG. 1). In some embodiments, BT communications may utilize the 2.4 GHz signal paths and may utilize the same FEM circuitry 200 as the one used for WLAN communications.

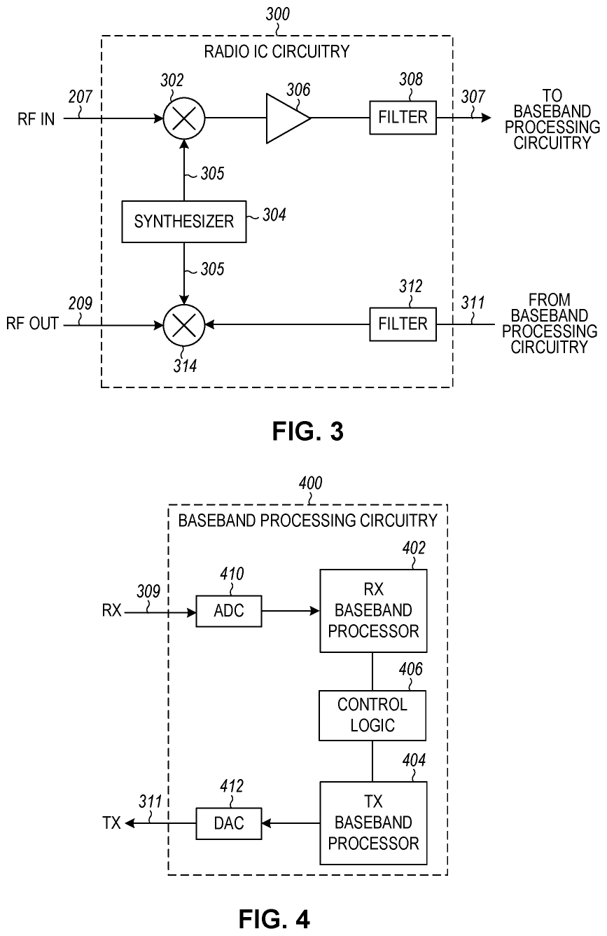

FIG. 3 illustrates radio integrated circuit (IC) circuitry 300 in accordance with some embodiments. The radio IC circuitry 300 is one example of circuitry that may be suitable for use as the WLAN radio IC circuitry 106A or the BT radio IC circuitry 106B (of FIG. 1). However, other circuitry configurations may also be suitable.

In some embodiments, the radio IC circuitry 300 may include a receive signal path and a transmit signal path. The receive signal path of the radio IC circuitry 300 may include mixer circuitry 302, such as, for example, down-conversion mixer circuitry, amplifier circuitry 306, and filter circuitry 308. The transmit signal path of the radio IC circuitry 300 may include filter circuitry 312 and mixer circuitry 314, such as up-conversion mixer circuitry. The radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture than standard super-heterodyne mixer circuitries, and any flicker noise brought about by the same may be alleviated, for example, through the use of OFDM modulation. FIG. 3 illustrates only a simplified version of a radio IC circuitry and may include, although not shown, embodiments where each of the depicted circuitries may include more than one component. For instance, mixer circuitry 302 and/or 314 may each include one or more mixers, and filter circuitry 308 and/or 312 may each include one or more filters, such as one or more BPFs and/or LPFs, according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the frequency 305 provided by synthesizer circuitry 304. The amplifier circuitry 306 may be configured to amplify the down-converted signals, and the filter circuitry 308 may include an LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert baseband signals 311 based on the frequency 305 provided by the synthesizer circuitry 304 to generate RF signals 209 for the FEM circuitry 104. The baseband signals 311 may be provided by the baseband processing circuitry 108 and may be filtered by filter circuitry 312. The filter circuitry 312 may include an LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion, respectively, with the help of synthesizer circuitry 304. In some embodiments, the mixer circuitry 302 and the mixer circuitry 314 may each include two or more mixers, each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment, quadrature passive mixers (e.g., for the in-phase (I) and quadrature-phase (Q) paths). In such an embodiment, RF signals 207 from FIG. 3 may be down-converted to provide I and Q baseband output signals to be sent to the baseband processor.

Quadrature passive mixers may be driven by zero and ninety-degree time-varying LO switching signals provided by a quadrature circuitry, which may be configured to receive an LO frequency (fLO) from a local oscillator or a synthesizer, such as frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in the duty cycle (the percentage of one period in which the LO signal is high) and/or offset (the difference between the start points of the period). In some embodiments, the LO signals may have a 25% duty cycle and a 50% offset. In some embodiments, each branch of the mixer circuitry (e.g., the in-phase (I) and quadrature-phase (Q) path) may operate at a 25% duty cycle, which may result in a significant reduction in power consumption.

The RF signals 207 (FIG. 2) may comprise a balanced signal, although the scope of the embodiments is not limited in this respect. The I and Q baseband output signals may be provided to the low-noise amplifier, such as amplifier circuitry 306 (FIG. 3) or filter circuitry 308 (FIG. 3).

In some embodiments, the output baseband signals 307 and the baseband signals 311 may be analog, although the scope of the embodiments is not limited in this respect. In some alternate embodiments, the output baseband signals 307, and the baseband signals 311 may be digital. In these alternate embodiments, the radio IC circuitry may include an analog-to-digital converter (ADC) and digital-to-analog converter (DAC) circuitry.

In some dual-mode embodiments, a separate radio IC circuitry may be provided for processing signals for each spectrum or for other spectrums not mentioned here. However, the scope of the embodiments is not limited in this respect.

In some embodiments, the synthesizer circuitry 304 may be a fractional-N synthesizer or a fractional N/N+1 synthesizer. However, the scope of the embodiments is not limited in this respect, as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage-controlled oscillator (VCO), although that is not a requirement. A divider control input may further be provided by either the baseband processing circuitry 108 (FIG. 1) or the application processor 111 (FIG. 1), depending on the desired output frequency. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as frequency 305. In contrast, in other embodiments, frequency 305 may be a fraction of the carrier frequency (e.g., one-half the carrier frequency, one-third the carrier frequency). In some embodiments, frequency 305 may be a LO frequency (fLO).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor 402 for processing receive baseband signals 309 provided by the radio IC circuitry 106 (FIG. 1) and a transmit baseband processor 404 for generating baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the receive baseband processor 402. In these embodiments, the baseband processing circuitry 400 may also include DAC 412 to convert digital baseband signals from the transmit baseband processor 404 to analog baseband signals.

In some embodiments that communicate OFDM signals or OFDMA signals, such as through the WLAN baseband processing circuitry 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the one or more antennas 101 (FIG. 1) may each comprise one or more directional or omnidirectional antennas, including, for example, dipole antennas, monopole antennas, patch antennas, loop antennas, microstrip antennas, or other types of antennas suitable for transmission of RF signals. In some multiple-input multiple-output (MIMO) embodiments, the antennas may be effectively separated to take advantage of spatial diversity and the different channel characteristics that may result. The one or more antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application-specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

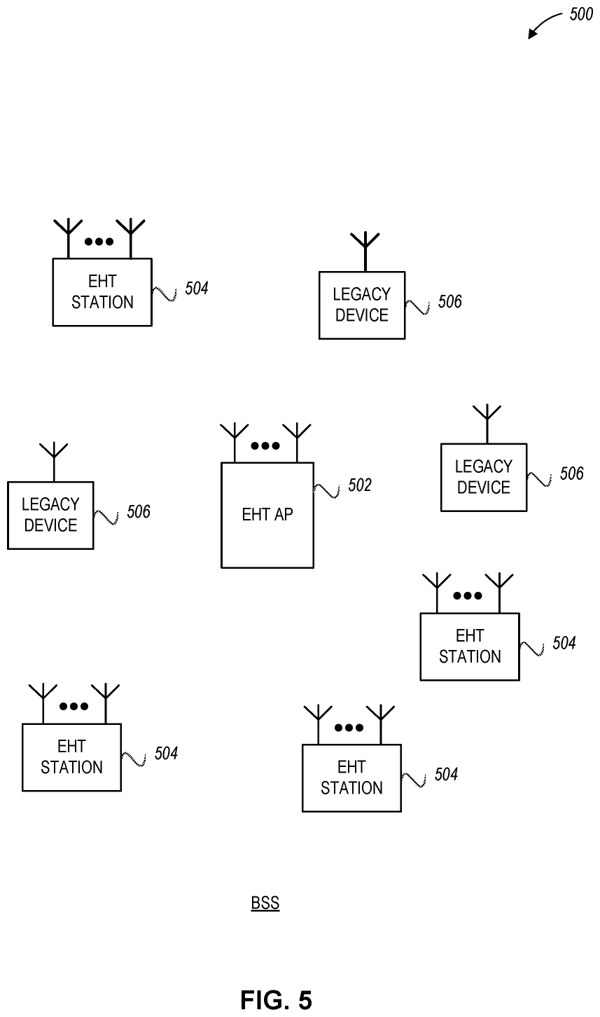

FIG. 5 illustrates a WLAN 500 in accordance with some embodiments. The WLAN 500 may comprise a basis service set (BSS) that may include a HE access point (AP) 502, which may be termed an AP, a plurality of extremely high throughput (EHT) (e.g., IEEE 802.11ax/be) stations (STAs) 504, and legacy devices 506 (e.g., IEEE 802.11g/n/ac devices). In some aspects, AP 502 is an EHT AP. In some embodiments, the EHT STAs 504 and/or AP 502 are configured to operate in accordance with IEEE 802.11 EHT. In some embodiments, the EHT STAs 504 and/or AP 502 are configured to operate in accordance with IEEE 802.11az. In some embodiments, IEEE 802.11EHT may be termed Next Generation 802.11. In some embodiments, the AP 502 may be configured to operate a HE BSS, ER BSS, and/or a BSS. Legacy devices may not be able to operate in the HE BSS, and beacon frames in the HE BSS may be transmitted using HE PPDUs. An ER BSS may use ER PPDUs to transmit the beacon frames, and legacy devices 506 may not be able to decode the beacon frames and thus are not able to operate in an ER BSS. The BSSs, e.g., BSS, ER BSS, and HE BSS, may use different BSSIDs.

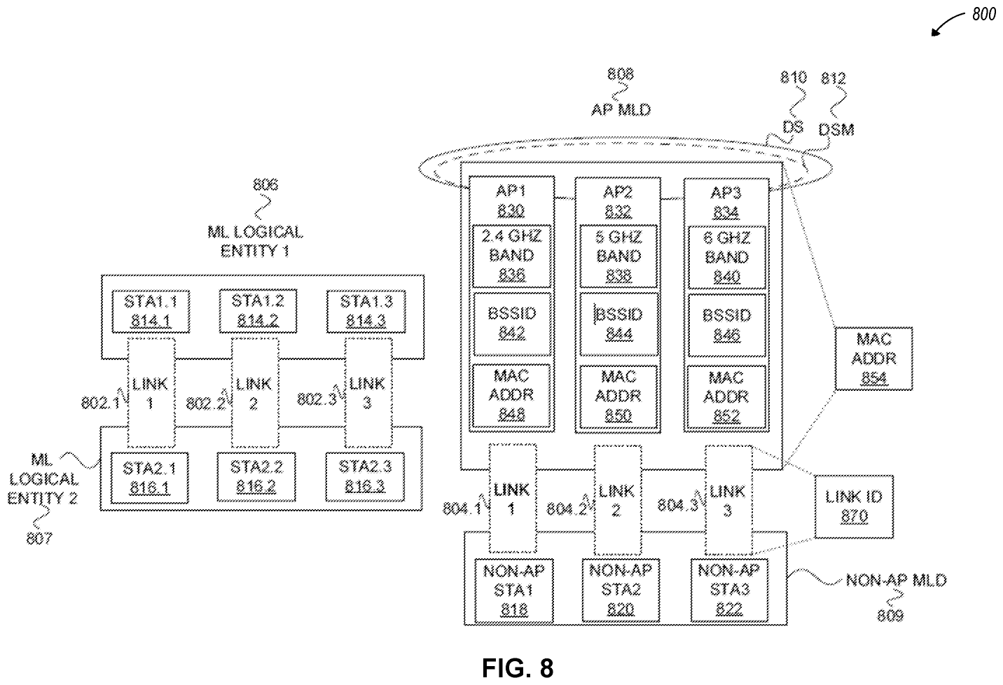

The AP 502 may be an AP using IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may be IEEE 802.11 next generation. The EHT protocol may be termed a different name in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to more than one HE APs and may control more than one BSS, e.g., assign primary channels, colors, etc. AP 502 may be connected to the Internet. The AP 502 and/or EHT STA 504 may be configured for one or more of the following: 320 MHz bandwidth, 16 spatial streams, multi-band or multi-stream operation, and 4096 QAM. Additionally, the AP 502 and/or EHT STA 504 may be configured for generating and processing EHT PPDUs that include an extension of the PE field (e.g., a dummy OFDM symbol) (e.g., as disclosed in conjunction with FIG. 8-FIG. 11) to meet both PHY and MAC processing time requirements.

The legacy devices 506 may operate in accordance with one or more of IEEE 802.11 a/b/g/n/ac/ad/af/ah/aj/ay, or another legacy wireless communication standard. The legacy devices 506 may be STAs or IEEE STAs. In some embodiments, when the AP 502 and EHT STAs 504 are configured to operate in accordance with IEEE 802.11EHT, the legacy devices 506 may include devices that are configured to operate in accordance with IEEE 802.11ax. The EHT STAs 504 may be wireless transmit and receive devices such as cellular telephones, portable electronic wireless communication devices, smart telephones, handheld wireless devices, wireless glasses, wireless watches, wireless personal devices, tablets, or another device that may be transmitting and receiving using the IEEE 802.11 protocol such as IEEE 802.11EHT or another wireless protocol. In some embodiments, the EHT STAs 504 may be termed extremely high throughput (EHT) stations or stations.

The AP 502 may communicate with legacy devices 506 in accordance with legacy IEEE 802.11 communication techniques. In example embodiments, the AP 502 may also be configured to communicate with EHT STAs 504 in accordance with legacy IEEE 802.11 communication techniques.

In some embodiments, a HE or EHT frame may be configurable to have the same bandwidth as a channel. The HE or EHT frame may be a Physical Layer Convergence Procedure (PLCP) Protocol Data Unit (PPDU). In some embodiments, there may be different types of PPDUs that may have different fields, different physical layers, and/or different media access control (MAC) layers. For example, a single-user (SU) PPDU, multiple-user (MU) PPDU, extended-range (ER) SU PPDU, and/or trigger-based (TB) PPDU. In some embodiments, EHT may be the same or similar to HE PPDUs.

The bandwidth of a channel may be 20 MHz, 40 MHz, or 80 MHz, 80+80 MHz, 160 MHz, 160+160 MHz, 320 MHz, 320+320 MHz, and 640 MHz bandwidths. In some embodiments, the bandwidth of a channel less than 20 MHz may be 1 MHz, 1.25 MHz, 2.03 MHz, 2.5 MHz, 4.06 MHz, 5 MHz, and 10 MHz, or a combination thereof or another bandwidth that is less or equal to the available bandwidth may also be used. In some embodiments, the bandwidth of the channels may be based on several active data subcarriers. In some embodiments, the bandwidth of the channels is based on 26, 52, 106, 242, 484, 996, or 2×996 active data subcarriers or tones that are spaced by 20 MHz. In some embodiments, the bandwidth of the channels is 256 tones spaced by 20 MHz. In some embodiments, the channels are a multiple of 26 tones or a multiple of 20 MHz. In some embodiments, a 20 MHz channel may comprise 242 active data subcarriers or tones, which may determine the size of a Fast Fourier Transform (FFT). An allocation of bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz, and 80+80 MHz OFDMA HE PPDU formats. In some embodiments, the 106-subcarrier RU is used in the 20 MHz, 40 MHz, 80 MHz, 160 MHz, and 80+80 MHz OFDMA and MU-MIMO HE PPDU formats. In some embodiments, the 242-subcarrier RU is used in the 40 MHz, 80 MHz, 160 MHz, and 80+80 MHz OFDMA and MU-MIMO HE PPDU formats. In some embodiments, the 484-subcarrier RU is used in the 80 MHz, 160 MHz, and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE or EHT frame may be configured for transmitting several spatial streams, which may be in accordance with MU-MIMO and may be in accordance with OFDMA. In other embodiments, the AP 502, the EHT STAB 504, and/or the legacy devices 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, low-power Bluetooth®, or other technologies.

In accordance with some IEEE 802.11 embodiments, e.g., IEEE 802.11EHT/ax embodiments, an AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL transmissions from EHT STAs 504. The AP 502 may transmit a time duration of the TXOP and sub-channel information. During the TXOP, EHT STAs 504 may communicate with the AP 502 in accordance with a non-contention-based multiple access technique such as OFDMA or MU-MIMO. This is unlike conventional WLAN communications in which devices communicate in accordance with a contention-based communication technique rather than multiple access techniques. During the HE or EHT control period, the AP 502 may communicate with EHT STAs 504 using one or more HE or EHT frames. During the TXOP, the EHT STAs 504 may operate on a sub-channel smaller than the operating range of the AP 502. During the TXOP, legacy stations refrain from communicating. The legacy stations may need to receive the communication from the AP 502 to defer from communicating.

In accordance with some embodiments, during the TXOP, the EHT STAs 504 may contend for the wireless medium, with the legacy devices 506 being excluded from contending for the wireless medium during the master-sync transmission. In some embodiments, the trigger frame may indicate a UL-MU-MIMO and/or UL OFDMA TXOP. In some embodiments, the trigger frame may include a DL UL-MU-MIMO and/or DL OFDMA with a schedule indicated in a preamble portion of the trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or EHT STAs 504 in accordance with legacy IEEE 802.11 communication techniques. In some embodiments, the AP 502 may also be configurable to communicate with EHT STAs 504 outside the HE TXOP in accordance with legacy IEEE 802.11 or IEEE 802.11EHT/ax communication techniques, although this is not a requirement.

In some embodiments, the EHT STA 504 may be a “group owner” (GO) for peer-to-peer modes of operation. A wireless device may be a HE station or an AP 502. In some embodiments, the EHT STA 504 and/or AP 502 may be configured to operate in accordance with IEEE 802.11mc. In example embodiments, the radio architecture of FIG. 1 is configured to implement the EHT STA 504 and/or the AP 502. In example embodiments, the front-end module circuitry of FIG. 2 is configured to implement the EHT STA 504 and/or the AP 502. In example embodiments, the radio IC circuitry of FIG. 3 is configured to implement the EHT STA 504 and/or the AP 502. In example embodiments, the base-band processing circuitry of FIG. 4 is configured to implement the EHT STA 504 and/or the AP 502.

In example embodiments, the EHT STAs 504, AP 502, an apparatus of the EHT STAs 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-11 or may be implemented as part of devices that perform such methods and operations/functions.

In example embodiments, the EHT STA 504 and/or the AP 502 are configured to perform the methods and operations/functions described herein in conjunction with FIGS. 1-11. In example embodiments, an apparatus of the EHT STA 504 and/or an apparatus of the AP 502 are configured to perform the methods and functions described herein in conjunction with FIGS. 1-11. The term Wi-Fi may refer to one or more of the IEEE 802.11 communication standards. AP and STA may refer to AP 502 and/or EHT STA 504 (or an HE STA) as well as legacy devices 506.

In some embodiments, a HE AP STA may refer to an AP 502 and/or an EHT STAB 504 that is operating as a HE AP. In some embodiments, when an EHT STA 504 is not operating as a HE AP, it may be referred to as a HE non-AP STA or HE non-AP. In some embodiments, EHT STA 504 may be referred to as either a HE AP STA or a HE non-AP. EHT may refer to a next-generation IEEE 802.11 communication protocol, which may be IEEE 802.11be or may be designated another name.

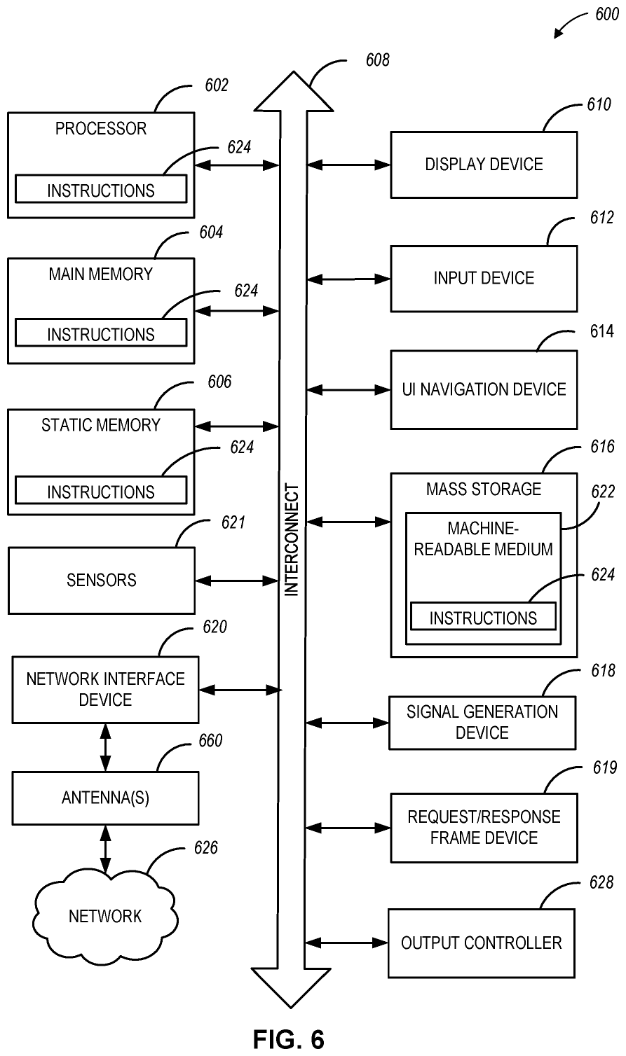

FIG. 6 illustrates a block diagram of an example machine 600 upon which any one or more of the techniques (e.g., methodologies) discussed herein may be performed. In alternative embodiments, the machine 600 may operate as a standalone device or may be connected (e.g., networked) to other machines. In a networked deployment, machine 600 may operate in the capacity of a server machine, a client machine, or both in server-client network environments. In an example, machine 600 may act as a peer machine in a peer-to-peer (P2P) (or other distributed) network environment. The machine 600 may be an AP 502, EHT station (STA) 504, personal computer (PC), a tablet PC, a set-top box (STB), a personal digital assistant (PDA), a portable communications device, a mobile telephone, a smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604, and a static memory 606, some or all of which may communicate with each other via an interlink (e.g., bus) 608.

Specific examples of main memory 604 include Random Access Memory (RAM) and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 600 may further include a display device 610, an input device 612 (e.g., a keyboard), and a user interface (UI) navigation device 614 (e.g., a mouse). In an example, the display device 610, the input device 612, and the UI navigation device 614 may be a touch screen display. The machine 600 may additionally include a storage device (e.g., drive unit) 616, a signal generation device 618 (e.g., a speaker), a request/response frame device 619, a network interface device 620, and one or more sensors 621, such as a global positioning system (GPS) sensor, compass, accelerometer, or other sensors. Machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, hardware processor 602 and/or instructions 624 may comprise processing circuitry and/or transceiver circuitry.

The storage device 616 may include a machine-readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or the hardware processor 602 during execution thereof by machine 600. In an example, one or any combination of the hardware processor 602, the main memory 604, the static memory 606, or the storage device 616 may constitute machine-readable media.

The request/response frame device 619 may carry out or perform any of the operations and processes (e.g., the processes described in FIG. 10 and FIG. 11) described herein. It is understood that the above is only a subset of what the request/response frame device 619 may be configured to perform. Other functions included throughout this disclosure may also be performed by the request/response frame device 619.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 622 is illustrated as a single medium, the term “machine-readable medium” may include a single medium or multiple media (e.g., a centralized or distributed database and/or associated caches and servers) configured to store instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, the network interface device 620, one or more antennas 660, a display device 610, an input device 612, a UI navigation device 614, a storage device 616, instructions 624, a signal generation device 618, and an output controller 628. The apparatus may be configured to perform one or more of the methods and/or operations disclosed herein. The apparatus may be intended as a component of machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 600 and that causes the machine 600 to perform any one or more of the techniques of the present disclosure or that is capable of storing, encoding or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 624 may further be transmitted or received over a communications network 626 using a transmission medium via the network interface device 620 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding, or carrying instructions for execution by the machine 600, and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a specific manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. The software may accordingly configure a hardware processor, for example, to constitute a particular module at one instance of time and to constitute a different module at a different instance of time.

Some embodiments may be implemented wholly or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, flash memory, etc.

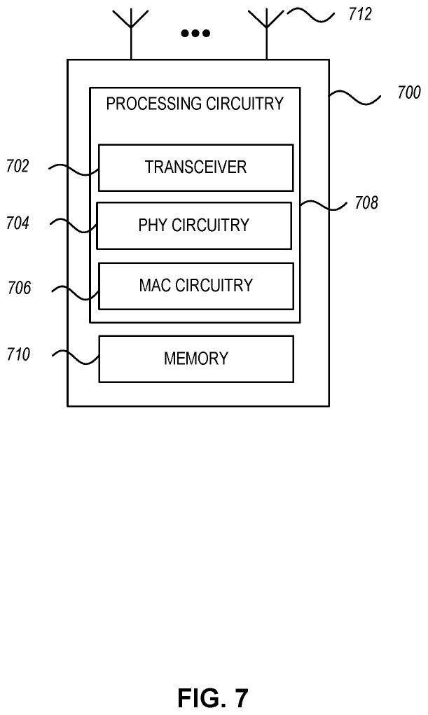

FIG. 7 illustrates a block diagram of an example wireless device 700 upon which any one or more of the techniques (e.g., methodologies or operations) discussed herein may be performed. The wireless device 700 may be a HE device or a HE wireless device. The wireless device 700 may be an EHT STA 504, AP 502, and/or a HE STA or HE AP. An EHT STA 504, AP 502, and/or a HE AP or HE STA may include some or all of the components shown in FIGS. 1-11. The wireless device 700 may be an example of machine 600, as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices (e.g., AP 502, EHT STA 504, and/or legacy devices 506) using one or more antennas 712. As an example, the PHY circuitry 704 may perform various encoding and decoding functions that may include the formation of baseband signals for transmission and decoding of received signals. As another example, the transceiver 702 may perform various transmission and reception functions, such as the conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to the transmission and reception of signals may be performed by a combination that may include one, any, or all of the PHY circuitry 704, the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in memory 710.

The one or more antennas 712 (some embodiments may include only one antenna) may comprise one or more directional or omnidirectional antennas, including, for example, dipole antennas, monopole antennas, patch antennas, loop antennas, microstrip antennas, or other types of antennas suitable for transmission of RF signals. In some multiple-input multiple-output (MIMO) embodiments, the one or more antennas 712 may be effectively separated to take advantage of spatial diversity and the different channel characteristics that may result.

One or more of the memory 710, the transceiver 702, the PHY circuitry 704, the MAC circuitry 706, the one or more antennas 712, and/or the processing circuitry 708 may be coupled with one another. Moreover, although memory 710, the transceiver 702, the PHY circuitry 704, the MAC circuitry 706, the one or more antennas 712 are illustrated as separate components, one or more of memory 710, the transceiver 702, the PHY circuitry 704, the MAC circuitry 706, the one or more antennas 712 may be integrated into an electronic package or chip.

In some embodiments, the wireless device 700 may be a mobile device, as described in conjunction with FIG. 6. In some embodiments, the wireless device 700 may be configured to operate under one or more wireless communication standards as described herein. In some embodiments, the wireless device 700 may include one or more of the components as described in conjunction with FIG. 6 (e.g., the display device 610, input device 612, etc.) Although the wireless device 700 is illustrated as having several separate functional elements, one or more of the functional elements may be combined and may be implemented by combinations of software-configured elements, such as processing elements, including digital signal processors (DSPs) and/or other hardware elements. For example, some elements may comprise one or more microprocessors, DSPs, field-programmable gate arrays (FPGAs), application-specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700, as shown in FIG. 7 and/or components from FIGS. 1-7. In some aspects, techniques and operations described herein that refer to the wireless device 700 may apply to an apparatus for a wireless device 700 (e.g., AP 502 and/or EHT STA 504). In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TXOP and encode or decode an HE PPDU. In some embodiments, the MAC circuitry 706 may be arranged to contend for the wireless medium based on channel contention settings, a transmitting power level, and a clear channel assessment level (e.g., energy detect level).

The PHY circuitry 704 may be arranged to transmit signals following one or more communication standards described herein. For example, the PHY circuitry 704 may be configured to transmit a HE PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM or based on special-purpose circuitry. The processing circuitry 708 may include a processor such as a general-purpose processor or a special-purpose processor. The processing circuitry 708 may implement one or more functions associated with one or more antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mmWave technology, communication between a station (e.g., the EHT STAB 504 of FIG. 5 or wireless device 700) and an access point (e.g., the AP 502 of FIG. 5 or wireless device 700) may use associated effective wireless channels that are highly directionally dependent. To accommodate the directionality, beamforming techniques may be utilized to radiate energy in a specific direction with a particular beam width to communicate between two devices. The directed propagation concentrates transmitted energy toward a target device to compensate for significant energy loss in the channel between the two communicating devices. Using directed transmission may extend the range of the millimeter-wave communication versus utilizing the same transmitted energy in omnidirectional propagation.

In the 802.11be standard, a mechanism has been defined that enables an Access Point Multilink Device (AP MLD) to recommend the link or links that associated non-AP MLDs should utilize. The primary objective of this mechanism is to facilitate efficient and dynamic load balancing. This load balancing process involves shifting traffic from non-AP MLDs to different links in order to enhance throughput, reduce latency, and alleviate congestion.

The mechanism is delineated as follows. An AP can transmit a Link Recommendation frame. This frame is broadcast and sent subsequent to the Delivery Traffic Indication Message (DTIM) beacons. At present, the Link Recommendation frame is defined as a protected action frame. The Link Recommendation frame encompasses an Association Identifier (AID) Bitmap element and a Multi-Link Traffic Indication element. The AID Bitmap element identifies the non-AP MLDs for which the AP provides a link recommendation in the frame. The Multi-Link Traffic Indication element contains the link recommendation (link bitmap) for each of the non-AP MLDs identified in the AID Bitmap element.

The collaboration between the TxBSSID and the NonTxBSSIDs results in more efficient use of network resources by reducing the number of Beacon frames that need to be sent, thereby saving bandwidth and mitigating network congestion.

In scenarios where the AP is part of a Multiple BSSID set, only the transmitted BSSID sends beacon frames for itself and all the non-transmitted BSSIDs within the same Multiple BSSID set. This approach is adopted to save the overhead of sending as many Beacon frames as there are non-transmitted BSSIDs.

In some aspects, a transmitted BSSID (TxBSSID) could transmit the link recommendation frame. This frame would provide a link recommendation not only for Stations (STAs) associated with the TxBSSID but also for STAs associated with non-transmitted BSSIDs (NonTxBSSIDs) within the same Multiple BSSID set. This strategy streamlines the link recommendation process, reducing the need for multiple frames from different BSSIDs and enhancing the overall efficiency of the network.

FIG. 8 illustrates multi-link devices (MLD)s 800, in accordance with some embodiments. Illustrated in FIG. 8 are ML logical entity 1 806, ML logical entity 2 807, AP MLD 808, and non-AP MLD 809. The ML logical entity 1 806 includes three STAs, STA1.1 814.1, STA1.2 814.2, and STA1.3 814.3 that operate in accordance with link 1 802.1, link 2 802.2, and link 3 802.3, respectively.

The links are different frequency bands such as 2.4 GHz band, 5 GHz band, 6 GHz band, and so forth. ML logical entity 2 807 includes STA2.1 816.1, STA2.2 816.2, and STA2.3 816.3, which operate in accordance with link 1 802.1, link 2 802.2, and link 3 802.3, respectively. In some embodiments, ML logical entity 1 806 and ML logical entity 2 807 operate in accordance with a mesh network. Using three links enables the ML logical entity 1 806 and ML logical entity 2 807 to operate using a greater bandwidth and more reliably as they can switch to using a different link if there is interference or if one link is superior due to operating conditions.

The distribution system (DS) 810 indicates how communications are distributed, and the DS medium (DSM) 812 indicates the medium that is used for the DS 810, which in this case is the wireless spectrum.

AP MLD 808 includes AP1 830, AP2 832, and AP3 834, operating on link 1 804.1, link 2 804.2, and link 3 804.3, respectively. AP MLD 808 includes a MAC address 854 that may be used by applications to transmit and receive data across one or more of AP1 830, AP2 832, and AP3 834. Each link may have an associated link ID. For example, as illustrated, link 3 804.3 has a link ID 870.

AP1 830, AP2 832, and AP3 834 include a frequency band, which are 2.4 GHz band 836, 5 GHz band 838, and 6 GHz band 840, respectively. AP1 830, AP2 832, and AP3 834 include different BSSIDs, which are BSSID 842, BSSID 844, and BSSID 846, respectively. AP1 830, AP2 832, and AP3 834 include different media access control (MAC) addresses (addr), which are MAC addr 848, MAC addr 850, and MAC addr 852, respectively. The AP 502 is an AP MLD 808 in accordance with some embodiments. The STA 504 is a non-AP MLD 809 in accordance with some embodiments.

The non-AP MLD 809 includes non-AP STA1 818, non-AP STA2 820, and non-AP STA3 822. Each of the non-AP STAs may have MAC addresses, and the non-AP MLD 809 may have a MAC address that is different and used by application programs where the data traffic is split up among non-AP STA1 818, non-AP STA2 820, and non-AP STA3 822.

The STA 504 is a non-AP STA1 818, non-AP STA2 820, or non-AP STA3 822, in accordance with some embodiments. The non-AP STA1 818, non-AP STA2 820, and non-AP STA3 822 may operate as if they are associated with a BSS of AP1 830, AP2 832, and AP3 834, respectively, over link 1 804.1, link 2 804.2, and link 3 804.3, respectively.

A multi-link (ML) device, such as ML logical entity 1 806 or ML logical entity 2 807, is a logical entity that contains STA1.1 814.1, STA1.2 814.2, STA1.3 814.3, STA2.1 816.1, STA2.2 816.2, and STA2.3 816.3. The ML logical entity 1 806 and ML logical entity 2 807 each has one MAC data service interface and primitives to the logical link control (LLC) and a single address associated with the interface, which can be used to communicate on the DSM 812. The multi-link logical entity allows STAs within the multi-link logical entity to have the same MAC address. In some embodiments, the same MAC address is used for application layers, and a different MAC address is used per link.

In an infrastructure framework, AP MLD 808 includes APs 830, 832, and 834 on one side, and non-AP MLD 809 includes non-AP STAs 818, 820, and 822 on the other side.

ML AP device (AP MLD) is an ML logical entity, where each STA within the multi-link logical entity is an EHT AP 502, in accordance with some embodiments. ML non-AP device (non-AP MLD) is a multi-link logical entity, where each STA within the multi-link logical entity is a non-AP EHT STA 504. AP1 830, AP2 832, and AP3 834 may be operating on different bands, and there may be fewer or more APs. There may be fewer or more STAs as part of the non-AP MLD 809.

In some embodiments, the AP MLD 808 is termed an AP MLD or MLD. In some embodiments, a non-AP MLD 809 is termed an MLD or a non-AP MLD. Each AP (e.g., AP1 830, AP2 832, and AP3 834) of the MLD sends a beacon frame that includes a description of its capabilities, operation elements, a basic description of the other APs of the same MLD that are collocated, which may be a report in a Reduced Neighbor Report element or another element such as a basic multi-link element. AP1 830, AP2 832, and AP3 834 transmit information about the other APs in beacons and probe response frames, enabling STAs of non-AP MLDs to discover the APs of the AP MLD.

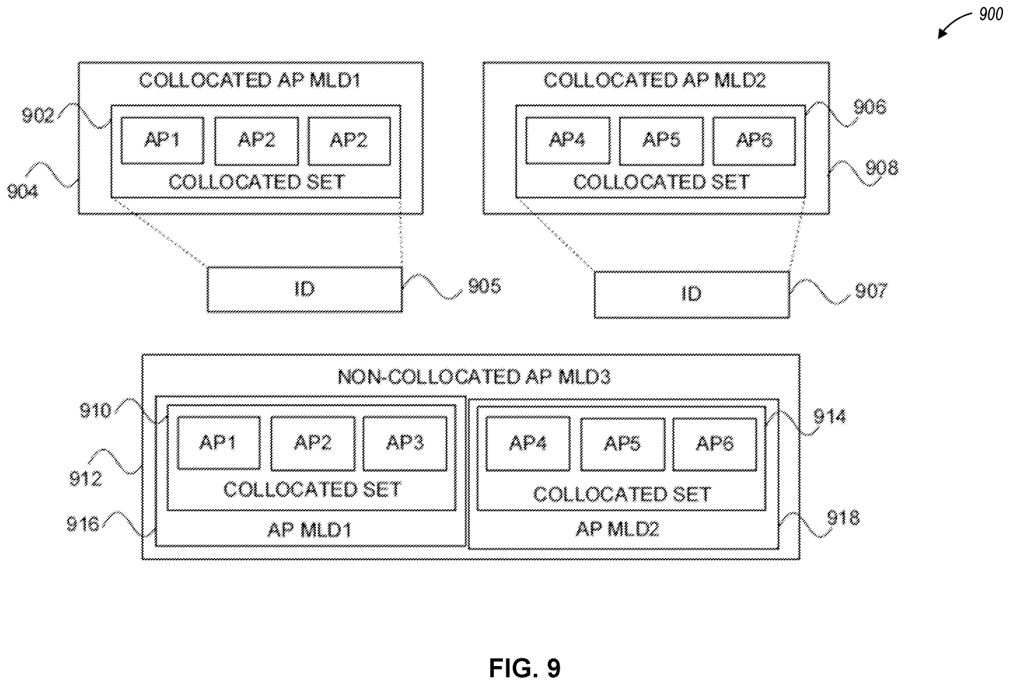

FIG. 9 illustrates a diagram 900 of collocated and non-collated MLDs, in accordance with some embodiments. The collocated AP MLD1 904 includes a collocated set 902 of APs, which are AP1, AP2, and AP3. The collocated AP MLD2 908 includes a collocated set 906 of APs, which are AP4, APS, and AP6. The collocated AP MLD1 904 and collocated AP MLD1 908 are AP MLD 808 and/or MLDs as disclosed in conjunction with IEEE P802.11be™/D3.0, January 2023, in accordance with some embodiments. The AP1-AP6 may be the same or similar as AP 502. The collocated set 902 may have an ID 905, and the collocated set 906 may have an ID 907. ID 905 and ID 907 may be used as part of the identification of the AP in the field collocated set ID or collocated AP MLD ID.

The non-collocated AP MLD3 912 comprises AP MLD1 916, which comprises collocated set 910, and AP MLD2 918, which comprises collocated set 914. The non-collocated AP MLD3 912 may be as disclosed in conjunction with IEEE P802.11be™/D3.2, May 2023 (“IEEE 802.11be”) or Wi-Fi 8, in accordance with some embodiments. As an example, AP MLD1 916 and AP MLD2 918 may be implemented on separate electronic devices and may be separated physically from one another. The non-collocated AP MLD3 may include hundreds or more AP MLDs. APs 502, such as AP1, AP2, . . . , and AP6, may be termed as affiliated if they are associated with the same MLD.

FIG. 10 is a network diagram illustrating an example network environment using request and response frames to address an exposed node issue in a wireless network, in accordance with some embodiments. Wireless network 1000 may include one or more user devices 1020 and one or more access points(s) (AP) 1002, which may communicate in accordance with IEEE 802.11 communication standards. The one or more user devices 1020 may be mobile devices that are non-stationary (e.g., not having fixed locations) or may be stationary devices.

In some embodiments, the one or more user devices 1020 and the one or more APs 1002 may include one or more computer systems similar to that of the functional diagram of FIG. 6 and/or the example machine/system of FIG. 7.

One or more user devices 1020 and/or one or more APs 1002 may be operable by one or more user(s) 1010. It should be noted that any addressable unit may be a station (STA). A STA may take on multiple distinct characteristics, each of which shapes its function. For example, a single addressable unit might simultaneously be a portable STA, a quality-of-service (QoS) STA, a dependent STA, and a hidden STA. The one or more user devices 1020 and the one or more APs 1002 may be STAs. The one or more user devices 1020 and/or the one or more APs 1002 may operate as a personal basic service set (PB SS) control point/access point (PCP/AP). The one or more user devices 1020 (e.g., 1024, 1026, or 1028) and/or the one or more APs 1002 may include any suitable processor-driven device, including, but not limited to, a mobile device or a non-mobile, e.g., a static device. For example, the one or more user devices 1020 and/or the one or more APs 1002 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc., may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet connectivity (e.g., dishwashers, etc.).

The one or more user devices 1020 and/or the one or more APs 1002 may also include mesh stations in, for example, a mesh network in accordance with one or more IEEE 802.11 standards and/or 3GPP standards.

Any of the one or more user devices 1020 (e.g., user devices 1024, 1026, 1028) and the one or more APs 1002 may be configured to communicate with each other via one or more communications networks 1030 and/or 1035 wirelessly or wired. The one or more user devices 1020 may also communicate peer-to-peer or directly with each other with or without the one or more APs 1002. Any of the one or more communications networks 1030 and/or 1035 may include, but is not limited to, any one of a combination of different types of suitable communications networks such as broadcasting networks, cable networks, public networks (e.g., the Internet), private networks, wireless networks, cellular networks, or any other suitable private and/or public networks. Further, any of the one or more communications networks 1030 and/or 1035 may have any suitable communication range associated therewith and may include, for example, global networks (e.g., the Internet), metropolitan area networks (MANs), wide area networks (WANs), local area networks (LANs), or personal area networks (PANs). In addition, any of the one or more communications networks 1030 and/or 1035 may include any medium over which network traffic may be carried, including, but not limited to, coaxial cable, twisted-pair wire, optical fiber, a hybrid fiber-coaxial (HFC) medium, microwave terrestrial transceivers, radio frequency communication mediums, white space communication mediums, ultra-high frequency communication mediums, satellite communication mediums, or any combination thereof.

Any of the one or more user devices 1020 (e.g., user devices 1024, 1026, 1028) and the one or more APs 1002 may include one or more communications antennas. The one or more communications antennas may be any suitable type of antenna corresponding to the communications protocols used by the one or more user devices 1020 (e.g., user devices 1024, 1026, and 1028) and the one or more APs 1002. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the one or more user devices 1020 and/or the one or more APs 1002.

Any of the one or more user devices 1020 (e.g., user devices 1024, 1026, 1028) and one or more APs 1002 may be configured to perform directional transmission and/or directional reception in conjunction with wirelessly communicating in a wireless network. Any of the one or more user devices 1020 (e.g., user devices 1024, 1026, 1028) and one or more APs 1002 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the one or more user devices 1020 (e.g., user devices 1024, 1026, 1028) and one or more APs 1002 may be configured to perform any given directional transmission towards one or more defined transmit sectors. Any of the one or more user devices 1020 (e.g., user devices 1024, 1026, 1028) and one or more APs 1002 may be configured to perform any given directional reception from one or more defined receive sectors.

MIMO beamforming in a wireless network may be accomplished using RF beamforming and/or digital beamforming. In some embodiments, in performing a given MIMO transmission, the one or more user devices 1020 and/or the one or more APs 1002 may be configured to use all or a subset of its one or more communications antennas to perform MIMO beamforming.

Any of the one or more user devices 1020 (e.g., user devices 1024, 1026, 1028) and one or more APs 1002 may include any suitable radio and/or transceiver for transmitting and/or receiving radio frequency (RF) signals in the bandwidth and/or channels corresponding to the communications protocols utilized by any of the one or more user devices 1020 and one or more APs 1002 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax, 802.11be, etc.), 6 GHz channels (e.g., 802.11ax, 802.11be, etc.), or 60 GHz channels (e.g., 802.11ad, 802.11ay). 800 MHz channels (e.g., 802.11ah). The communications antennas may operate at 28 GHz and 40 GHz. It should be understood that this list of communication channels in accordance with specific 802.11 standards is only a partial list and that other 802.11 standards may be used (e.g., Next Generation Wi-Fi or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and a digital baseband.

In one embodiment, and with reference to FIG. 10, a user device of the one or more user devices 1020 may be communicating with the one or more APs 1002. The one or more APs 1002 may be multi-link devices (MLDs or AP MLDs), and the one or more user device 1020 may be non-AP MLDs. Each of the one or more APs 1002 may comprise a plurality of individual APs (e.g., AP1, AP2, . . . , APn, where n is an integer), and each of the one or more user devices 1020 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for purposes of illustration and are not meant to be limiting.

In some aspects, the disclosed techniques define a way for a STA to be allowed to use prioritized channel access using a defer signal, such as when the STA is in an exposed node situation.

In some aspects, a STA (e.g., the one or more user devices 1020) is in an exposed mode situation when one or more of the following conditions occur:
(a) The STA has received X number of consecutive Basic Trigger frames that the STA is not allowed to respond to (e.g., by sending an uplink trigger-based physical layer protocol data unit or UL TB PPDU and including data frames) because its NAV is set. In some aspects, the value of X can be pre-defined in a specification or through a parameter that is valid for the BSS and is advertised in the Beacon frames transmitted by the associated AP or at least in the association response frame transmitted by the AP during the STA association. The term “consecutive” indicates that frames cannot be in the middle of a Basic Trigger frame that the STA is allowed to respond to. Otherwise, the Trigger Frame counter is reset to 0. However, there can be other Trigger frames addressed to other STAs in the middle, for instance.
(b) The STA has data in its queues and is invoking the backoff procedure and trying to access the medium. It detects Y number of consecutive contention periods (detecting the end of a transmit opportunity or TxOP) that it cannot participate in because its NAV is set at the beginning of the contention period.

If the STA meets any of the above conditions, it is allowed to access the medium with a Defer Signal.

In some aspects, a STA that is experiencing a recurrent and persistent exposed node situation (e.g., one or more user devices 1020) is often not able to respond to a Basic Trigger frame sent by its associated AP and addressed to it because its NAV is set, or it is not able to participate in a majority of contention periods because the NAV is set at the beginning of the contention period), is allowed to request its associated AP to define a protected period during which it will try and create the conditions so that NAV is not set.

In some aspects, the disclosed techniques include defining a Request frame (e.g., request frame 1040) sent by a STA (e.g., to its associated AP (e.g., one or more APs 1002) and asking the AP to create a protected period for the STA. In some aspects, the Request frame may include:
(a) The preferred timing parameters of a periodic service period (optionally, it can also leave that to the AP).
(b) The proportion of contention periods that the STA cannot participate in because the NAV is set.
(c) The proportion of the Basic trigger frame that the STA cannot respond to because the NAV is set.
(d) The list of BSSIDs or BSS colors of one or more APs that are responsible for setting the NAV on the STA.

When receiving such a request frame, the AP may reach out to the neighboring APs that are identified by the Request frames as the one or more APs responsible for setting the NAV on the STA, and ask the one or more APs to create a Coordinated restricted target wake time (R-TWT) period, applying the coordinated restricted target wake time (C-rTWT) procedure (e.g., using C-rTWT Request/Response frame, etc.). Suppose the one or more APs agree to extend the protection of the rTWT. In that case, these APs will advertise that rTWT in their beacons so that their associated STAs supporting rTWT will end their TxOP at the start of the rTWT, and the associated AP will also advertise the rTWT.

The associated AP will then send a Response frame (e.g., response frame 1042) to the STA indicating that it has successfully established an rTWT for the STA and that it has managed to coordinate that with some or all of the neighbor APs responsible for setting the NAV.

Alternatively, the STA can be allowed to send a Request frame to the neighbor AP (e.g., the one or more APs mentioned above that cause the NAV) in the name of its associated AP in order to extend the protection of the rTWT SP in case the neighbor AP and the associated AP are in a hidden node situation and cannot exchange frames.

FIG. 11 is a flow diagram of an example method 1100 for using prioritized channel access in a wireless network with an exposed node, in accordance with some embodiments. Method 1100 includes operations 1102, 1104, and 1106, which can be performed by one or more components of the wireless device 700 of FIG. 7 or machine 600 of FIG. 6 (e.g., by the request/response frame device 619).

At operation 1102, a trigger frame is encoded for transmission to a plurality of station devices (STAs) in a wireless network.

At operation 1104, a first request frame (e.g., request frame 1040) received from a STA of the plurality of STAs is decoded. The first request frame requests the AP to create a protected period for the STA when the STA is in an exposed node situation.

At operation 1106, a second request frame is encoded for transition to at least a second AP in response to the first request frame. The second request frame requests the at least second AP to establish a restricted target wake time (rTWT) for the STA.

At operation 1108, a first response frame from the at least second AP is decoded. The first response frame includes an indication of whether the rTWT is established.

At operation 1110, a second response frame (e.g., response frame 1042) is encoded for transmission to the STA. The second response frame includes the indication.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

Some embodiments may be implemented wholly or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media; flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either concerning a particular example (or one or more aspects thereof) or concerning other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” etc., are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments, such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system. However, the scope of the disclosure is not limited in this respect.

Antennas referred to herein may comprise one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each antenna and the antennas of a transmitting station. In some MIMO embodiments, antennas may be separated by up to 1/10 of a wavelength or more.

Described implementations of the subject matter can include one or more features, alone or in combination, as illustrated below by way of examples.

Example 1 is an apparatus of an access point (AP), the apparatus comprising memory and processing circuitry coupled to the memory; the processing circuitry is to: encode a trigger frame for transmission to a plurality of station devices (STAs) in a wireless network; decode a first request frame received from a STA of the plurality of STAs, the first request frame requesting the AP to create a protected period for the STA when the STA is in an exposed node situation; encode a second request frame for transmission to at least a second AP in response to the first request frame, the second request frame requesting the at least second AP to establish a restricted target wake time (rTWT) for the STA; decode a first response frame from the at least second AP, the first response frame including an indication of whether the rTWT is established; and encode a second response frame for transmission to the STA, the second response frame including the indication.

In Example 2, the subject matter of Example 1 includes subject matter where the processing circuitry is to decode the first request frame to obtain one or more preferred timing parameters of a periodic service period, wherein the rTWT is based at least in part on the one or more preferred timing parameters.

In Example 3, the subject matter of Example 2 includes subject matter where the processing circuitry is to decode the first request frame to obtain a proportion of contention periods that the STA cannot participate in due to a network allocation vector (NAV) of the STA being set, wherein the rTWT is further based at least in part on the proportion of contention periods.

In Example 4, the subject matter of Examples 1-3 includes subject matter where the processing circuitry is to decode the first request frame to obtain a proportion of basic trigger frames from the AP that the STA cannot respond to due to a network allocation vector (NAV) of the STA being set, wherein the rTWT is based at least in part on the proportion of basic trigger frames.

In Example 5, the subject matter of Examples 1-4 includes subject matter where the processing circuitry is to decode the first request frame to obtain a list of basic service set identifiers (BSSIDs) or basic service set (BSS) colors of the at least second AP, the at least second AP being responsible for setting a network allocation vector (NAV) of the STA causing the STA to be placed in the exposed node situation.

In Example 6, the subject matter of Example 5 includes subject matter where the processing circuitry is to encode the second request frame for transition to the at least second AP based on the BSSIDs or the BSS colors in the list.

In Example 7, the subject matter of Example 6 includes subject matter where the second request frame further requests the at least second AP to establish the rTWT for the STA using a coordinated rTWT (C-rTWT) procedure.

In Example 8, the subject matter of Examples 1-7 includes a transceiver configured to transmit and receive wireless signals.

In Example 9, the subject matter of Example 8 includes one or more antennas coupled to the transceiver, wherein the transceiver is to transmit the trigger frame and the second request frame via the one or more antennas.

Example 10 is an apparatus of a station (STA), and the apparatus comprising memory and processing circuitry coupled to the memory; the processing circuitry is to detect the STA is in an exposed node situation; the exposed node situation based on the STA receiving a number of consecutive trigger frames that the STA is not allowed to respond to due to its network allocation vector (NAV) being set by at least a second AP; encode a request frame for transmission to the AP based on detecting the STA is in the exposed node situation, the request frame requesting the AP to create a protected period for the STA; decode a response frame received from the AP, the response frame including an indication of whether the at least second AP has established a restricted target wake time (rTWT) as the protected period for the STA; and encode a response to at least another trigger frame for transmission to the AP during the rTWT.

In Example 11, the subject matter of Example 10 includes subject matter where the processing circuitry is to encode the request frame to include one or more preferred timing parameters of a periodic service period, wherein the rTWT is based at least in part on the one or more preferred timing parameters.

In Example 12, the subject matter of Examples 10-11 includes subject matter where the processing circuitry is to encode the request frame to include a proportion of contention periods that the STA cannot participate in due to the NAV being set, wherein the rTWT is further based at least in part on the proportion of contention periods.

In Example 13, the subject matter of Examples 10-12 includes subject matter where the processing circuitry is to encode the request frame to include a proportion of basic trigger frames from the AP that the STA cannot respond to due to the NAV being set, wherein the rTWT is based at least in part on the proportion of basic trigger frames.

Example 14 is a non-transitory computer-readable storage medium that stores instructions for execution by one or more processors of an access point (AP), the instructions causing the one or more processors to: encode a trigger frame for transmission to a plurality of station devices (STAs) in a wireless network; decode a first request frame received from an STA of the plurality of STAs, the first request frame requesting the AP to create a protected period for the STA when the STA is in an exposed node situation; encode a second request frame for transition to at least a second AP in response to the first request frame, the second request frame requesting the at least second AP to establish a restricted target wake time (rTWT) for the STA; decode a first response frame from the at least second AP, the first response frame including an indication of whether the rTWT is established; and encode a second response frame for transmission to the STA, the second response frame including the indication.

In Example 15, the subject matter of Example 14 includes subject matter where the instructions further cause the one or more processors to decode the first request frame to obtain one or more preferred timing parameters of a periodic service period, wherein the rTWT is based at least in part on the one or more preferred timing parameters.

In Example 16, the subject matter of Example 15 includes subject matter where the instructions further cause the one or more processors to decode the first request frame to obtain a proportion of contention periods that the STA cannot participate in due to a network allocation vector (NAV) of the STA being set, wherein the rTWT is further based at least in part on the proportion of contention periods.

In Example 17, the subject matter of Examples 14-16 includes subject matter where the instructions further cause the one or more processors to decode the first request frame to obtain a proportion of basic trigger frames from the AP that the STA cannot respond to due to a network allocation vector (NAV) of the STA being set, wherein the rTWT is based at least in part on the proportion of basic trigger frames.

In Example 18, the subject matter of Examples 14-17 includes subject matter where the instructions further cause the one or more processors to decode the first request frame to obtain a list of basic service set identifiers (BSSIDs) or basic service set (BSS) colors of the at least second AP, the at least second AP being responsible for setting a network allocation vector (NAV) on the STA causing the STA to be placed in the exposed node situation.

In Example 19, the subject matter of Example 18 includes subject matter where the instructions further cause the one or more processors to encode the second request frame for transition to the at least second AP based on the BSSIDs or the BSS colors in the list.

In Example 20, the subject matter of Example 19 includes subject matter where the second request frame further requests the at least second AP to establish the rTWT for the STA using a coordinated rTWT (C-rTWT) procedure.

Example 21 is at least one machine-readable medium, including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

The above description is intended to be illustrative and not restrictive. For example, the above-described examples (or one or more aspects thereof) may be used in combination with others. Other embodiments may be used, such as by one of ordinary skill in the art upon reviewing the above description. The Abstract allows the reader to ascertain the nature of the technical disclosure quickly. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

The Abstract is provided to comply with 37 C.F.R. Section 1.72(b), which requires an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point (AP), the apparatus comprising:
memory; and
processing circuitry coupled to the memory, the processing circuitry is to:
encode a trigger frame for transmission to a plurality of station devices (STAs) in a wireless network;
decode a first request frame received from a STA of the plurality of STAs, the first request frame requesting the AP to create a protected period for the STA when the STA is in an exposed node situation;
encode a second request frame for transmission to at least a second AP in response to the first request frame, the second request frame requesting the at least second AP to establish a restricted target wake time (rTWT) for the STA;
decode a first response frame from the at least second AP, the first response frame including an indication of whether the rTWT is established; and
encode a second response frame for transmission to the STA, the second response frame including the indication.

2. The apparatus of claim 1, wherein the processing circuitry is to:
decode the first request frame to obtain one or more preferred timing parameters of a periodic service period, wherein the rTWT is based at least in part on the one or more preferred timing parameters.

3. The apparatus of claim 2, wherein the processing circuitry is to:
decode the first request frame to obtain a proportion of contention periods that the STA cannot participate in due to a network allocation vector (NAV) of the STA being set, wherein the rTWT is further based at least in part on the proportion of contention periods.

4. The apparatus of claim 1, wherein the processing circuitry is to:
decode the first request frame to obtain a proportion of basic trigger frames from the AP that the STA cannot respond to due to a network allocation vector (NAV) of the STA being set, wherein the rTWT is based at least in part on the proportion of basic trigger frames.

5. The apparatus of claim 1, wherein the processing circuitry is to:
decode the first request frame to obtain a list of basic service set identifiers (BSSIDs) or basic service set (BSS) colors of the at least second AP, the at least second AP being responsible for setting a network allocation vector (NAV) of the STA causing the STA to be placed in the exposed node situation.

6. The apparatus of claim 5, wherein the processing circuitry is to:
encode the second request frame for transition to the at least second AP based on the BSSIDs or the BSS colors in the list.

7. The apparatus of claim 6, wherein the second request frame further requests the at least second AP to establish the rTWT for the STA using a coordinated rTWT (C-rTWT) procedure.

8. The apparatus of claim 1, further comprising:
a transceiver configured to transmit and receive wireless signals.

9. The apparatus of claim 8, further comprising:
one or more antennas coupled to the transceiver, wherein the transceiver is to transmit the trigger frame and the second request frame via the one or more antennas.

10. An apparatus of a station (STA), and the apparatus comprising:
memory; and
processing circuitry coupled to the memory, the processing circuitry is to:
detect the STA is in an exposed node situation, the exposed node situation based on the STA receiving a number of consecutive trigger frames that the STA is not allowed to respond to due to its network allocation vector (NAV) being set by at least a second AP;
encode a request frame for transmission to the AP based on detecting the STA is in the exposed node situation, the request frame requesting the AP to create a protected period for the STA;
decode a response frame received from the AP, the response frame including an indication of whether the at least second AP has established a restricted target wake time (rTWT) as the protected period for the STA; and
encode a response to at least another trigger frame for transmission to the AP during the rTWT.

11. The apparatus of claim 10, wherein the processing circuitry is to:
encode the request frame to include one or more preferred timing parameters of a periodic service period, wherein the rTWT is based at least in part on the one or more preferred timing parameters.

12. The apparatus of claim 10, wherein the processing circuitry is to:
encode the request frame to include a proportion of contention periods that the STA cannot participate in due to the NAV being set, wherein the rTWT is further based at least in part on the proportion of contention periods.

13. The apparatus of claim 10, wherein the processing circuitry is to:
encode the request frame to include a proportion of basic trigger frames from the AP that the STA cannot respond to due to the NAV being set, wherein the rTWT is based at least in part on the proportion of basic trigger frames.

14. A non-transitory computer-readable storage medium that stores instructions for execution by one or more processors of an access point (AP), the instructions causing the one or more processors to:
encode a trigger frame for transmission to a plurality of station devices (STAs) in a wireless network;
decode a first request frame received from an STA of the plurality of STAs, the first request frame requesting the AP to create a protected period for the STA when the STA is in an exposed node situation;
encode a second request frame for transition to at least a second AP in response to the first request frame, the second request frame requesting the at least second AP to establish a restricted target wake time (rTWT) for the STA;
decode a first response frame from the at least second AP, the first response frame including an indication of whether the rTWT is established; and
encode a second response frame for transmission to the STA, the second response frame including the indication.

15. The non-transitory computer-readable storage medium of claim 14, wherein the instructions further cause the one or more processors to:
decode the first request frame to obtain one or more preferred timing parameters of a periodic service period, wherein the rTWT is based at least in part on the one or more preferred timing parameters.

16. The non-transitory computer-readable storage medium of claim 15, wherein the instructions further cause the one or more processors to:
decode the first request frame to obtain a proportion of contention periods that the STA cannot participate in due to a network allocation vector (NAV) of the STA being set, wherein the rTWT is further based at least in part on the proportion of contention periods.

17. The non-transitory computer-readable storage medium of claim 14, wherein the instructions further cause the one or more processors to:
decode the first request frame to obtain a proportion of basic trigger frames from the AP that the STA cannot respond to due to a network allocation vector (NAV) of the STA being set, wherein the rTWT is based at least in part on the proportion of basic trigger frames.

18. The non-transitory computer-readable storage medium of claim 14, wherein the instructions further cause the one or more processors to:
decode the first request frame to obtain a list of basic service set identifiers (BSSIDs) or basic service set (BSS) colors of the at least second AP, the at least second AP being responsible for setting a network allocation vector (NAV) on the STA causing the STA to be placed in the exposed node situation.

19. The non-transitory computer-readable storage medium of claim 18, wherein the instructions further cause the one or more processors to:
encode the second request frame for transition to the at least second AP based on the BSSIDs or the BSS colors in the list.

20. The non-transitory computer-readable storage medium of claim 19, wherein the second request frame further requests the at least second AP to establish the rTWT for the STA using a coordinated rTWT (C-rTWT) procedure.
